(19) United States
(12) Patent Application Publication
(10) Pub. No.: US 2009/0011197 A1
(43) Pub. Date: Jan. 8, 2009

(54) Electronic device

(76) Inventor: Tsutomu Matsuhira, Chiba-shi (JP)

Correspondence Address: BRUCE L. ADAMS, ESQ;ADAMS & WILKS, SUITE 1231, 17 BATTERY PLACE, New York, NY, 10004, US

(21) Appl. No.: 12/215,167

(22) Filed: Jun. 25, 2008

(30) Foreign Application Priority Data
Jun. 26, 2007 (JP) 2007-167103

(51) Int. Cl. B32B 5/00

(52) U.S. Cl. 428/192

(57) ABSTRACT

Provided is an electronic device in which a display panel fixed by a metal bezel is entirely bonded to a touch panel or a transparent plate for protection with a liquid adhesive so that the liquid adhesive is prevented from permeating a gap between the metal bezel and the display panel. In other words, the display panel is adhered to the metal bezel by providing an adhesive or the like there between. The display device of the aforementioned structure is bonded to the touch panel or the transparent plate for protection by filling an entire surface of the gap there between with a liquid transparent adhesive. Further, the adhesive or the like is made to have conductivity, and a transparent conductive film is formed on a surface of the display panel, whereby the transparent conductive film is electrically connected to the metal bezel, which provides counter-measures against static electricity.

### BACKGROUND OF THE INVENTION

1. Field of the Invention

The present invention relates to a method and a structure for entirely bonding a transparent plate for protection or a transparent touch panel to a display device with a liquid adhesive. For instance, the present invention relates to a structure, in a device such as a cell phone, for bonding the transparent plate for protection or the touch panel to a front surface of the display device. For the transparent plate for protection, a material such as polycarbonate; acrylic, alkali-free glass, soda-lime glass, chemically strengthened glass, air-cooled strengthened glass, or sapphire glass is used. Depending on products, a frame-like printing may also be formed on the transparent plate for protection. As to the touch panel, there are various types such as an analog resistive touch panel, a digital resistive touch panel, an ultrasonic touch panel, an optical touch panel, an acoustic touch panel, an electromagnetic induction touch panel, and a capacitance touch panel. As the display device, for example, there are an active matrix liquid crystal display device which drives liquid crystal using a transistor or a diode, a liquid crystal display device in which polymer network liquid crystal, STN liquid crystal, TN liquid crystal, phase stability nematic liquid crystal, smectic liquid crystal, or the like is disposed between transparent electrodes to be displayed by dynamic drive or static drive, a plasma display, an organic electroluminescence (EL) display, an inorganic EL display, a field emission display (FED), and an electronic paper.

2. Description of the Related Art

In the display device exemplified above, a display material (such as liquid crystal material, organic EL material, and plasma emitting structure) is held or formed between a transparent substrate of a display surface side and a counter substrate opposed thereto. On a surface of the transparent substrate of the display surface side, a polarizing plate or an optical film such as a film which shields electromagnetic waves and a UV protection film is arranged according to the type of the display device.

As a method of arranging a transparent touch panel or a transparent plate (herein after, collectively referred to as a transparent flat body) on the display surface of the display device, there is known a method of providing a double-sided adhesive having a thickness of 0.5 mm or more on a periphery of the display surface of the display device to adhere and fix a transparent flat body. Alternatively, there is known a method of entirely bonding a display panel of a display device to a touch panel using an optical adhesive (for example, see JP 61-131314 A). In the case where a display panel having an optical film disposed on the display surface side is bonded to a touch panel having a larger shape compared with the display panel using an adhesive layer, a spacer is often disposed on a rim of the optical film of the display panel such that the adhesive layer is made to have substantially a uniform thickness (for example, see JP 10-83247 A).

For example, the transparent plate and the liquid crystal panel provided on the display screen of a cellular phone are disposed while interposing an elastic body such as rubber having a thickness of 0.3 to 0.5 mm there between in an opaque region which is formed of a printing or the like on a periphery of a display area of the liquid crystal panel and outside a display area of the transparent plate. In particular, there are increasing needs for a cellular phone having a slimmer space between the transparent plate and the display panel, which is 0.2 mm or less.

For the transparent plate, a transparent plastic such as acrylic and polycarbonate or glass is used. On the surface of the transparent plate, in many cases, there is provided a low-reflecting film in which a material having a gradually-changing reflective index are formed through lamination, an electromagnetic shield which is formed of copper or aluminum and has a lattice-like etching pattern, hard coating for preventing damage, or a fluorine or silicone stain prevention film to which stains such as a sweat or fingerprints hardly to adhere. Further, in the case of glass, a film sheet for preventing a crack is attached to a surface of the transparent plat, a film sheet subjected to an anti-glare treatment for preventing specular reflection, or the like is attached to the surface thereof. Most transparent plates or display panels are rectangular in shape.

Besides, in some cases, wiring is formed by a conductive paste including copper or silver, or copper on a periphery of the touch panel. In other cases, printing is formed with a thickness of 10 μm on a front surface or a rear surface thereof.

In a touch panel where a sensor is not provided directly on the display panel, such as an optical touch panel, an electromagnetic induction touch screen, and an acoustic touch panel, the transparent panel for protection is often disposed to prevent an optical film of a polarizing plate or the like provided on the display surface from being damaged.

Moreover, as a structure for attaching a display panel, there is known a method of fixing a display panel by a metal bezel in which a portion of the display screen is hollowed (for example, see JP 2006-178134 A). If the display panel is easily affected by static electricity, there is employed a method of forming a transparent conductive film in a surface of a glass substrate or a polarizing plate which is attached to a surface thereof (for example, see JP 06-18931 A). As a method of connecting the transparent conductive film of the glass substrate or the polarizing plate to the ground, there is a method of connecting the metal bezel to GND while being brought into contact with the polarizing plate surface (for example, see JP 05-188388 A).

When the transparent flat body is entirely bonded to the display device of the structure where the display panel is fixed by a metal bezel using a light curable optical adhesive of a liquid type, there arise problems as described below. In other words, if there is a gap between the display panel and the metal bezel, the adhesive is impregnated between the metal bezel and the display panel, and the impregnated adhesive is not irradiated, whereby the adhesive is not cured. Alternatively, when a surface of the metal bezel is higher than a surface of the polarizing plate by approximately 50 μm, an adhesive layer needs to be made thicker. Even in the case of a structure where the metal bezel is brought into contact with the transparent conductive film formed on the glass surface or the surface of the polarizing plate of the display panel, the liquid optical adhesive is impregnated between the display panel and the metal bezel, and thus the impregnated adhesive cannot be cured.

Then, an object of the present invention is to obtain a structure where the display panel attached by the metal bezel is stably bonded to the transparent flat body without penetration of an adhesive at low cost.

### SUMMARY OF THE INVENTION

Therefore, in order to solve the aforementioned problems, in an electronic device of a structure where a transparent flat body is bonded to a full surface of a display device by an optical adhesive, a resin for preventing the optical adhesive from being impregnated is provided in a gap between a display panel and a metal bezel which fixes the display panel of the display device.

As a first structure, the resin is provided between the metal bezel and an optical film provided on a display surface of the display panel, where the metal bezel coincides with the display panel. In this case, as counter-measures against static, a resin having conductivity is used, and a transparent conductive film is formed on a surface of the optical film, whereby the transparent conductive film is electrically connected to the metal bezel.

As a second structure, the resin is provided between the metal bezel and a transparent substrate of the display panel, which is positioned in a place of coinciding with the metal bezel. In this case, as counter-measures against static, the resin having conductivity is used, and the transparent conductive film is formed on the surface of the transparent substrate, whereby the transparent conductive film is electrically connected to the metal bezel.

Further, as a third structure, a tape is used for fixation to cover a boundary between the metal bezel and the display panel. In this case, as counter-measures against static, the transparent conductive film is formed on the surface of the optical film provided on the surface of the display panel, and a tape having conductivity is used on its adhesive surface, whereby the metal bezel is electrically connected to the transparent conductive film.

Further, as a fourth structure, a gap between the metal bezel and the display panel or a periphery thereof is bonded with no space using an adhesive for the resin. In this case, as counter-measures against static, the metal bezel is bonded to the transparent conductive film formed on the transparent substrate or the optical film of the display panel, whereby the metal bezel is electrically connected to the transparent conductive film.

Still further, as another structure, the transparent film for filling a step formed between the surface of the display panel and the surface of the metal bezel is bonded to at least one of the display panel and the transparent plate.

### BRIEF DESCRIPTION OF THE DRAWINGS

In the accompanying drawings:

FIG. 1 is a schematic diagram showing a cross-sectional structure of Embodiment 1 of the present invention;

FIG. 2 is a schematic diagram showing a cross-sectional structure of Embodiment 2 of the present invention;

FIG. 3 is a schematic diagram showing a cross-sectional structure of Embodiment 3 of the present invention;

FIG. 4 is a schematic diagram showing a cross-sectional structure of Embodiment 4 of the present invention;

FIG. 5 is a schematic diagram showing a cross-sectional structure of Embodiment 5 of the present invention;

FIG. 6 is a schematic diagram showing a cross-sectional structure of Embodiment 6 of the present invention;

FIG. 7 is a schematic diagram showing a cross-sectional structure of Embodiment 7 of the present invention; and

FIG. 8 is a schematic diagram showing a cross-sectional structure of Embodiment 8 of the present invention.

### DETAILED DESCRIPTION OF THE PREFERRED EMBODIMENTS

An electronic device according to the present invention is an electronic device in which a transparent flat body is bonded to a display device with an optical adhesive, and a display panel of the display device is fixed by a metal bezel provided on a periphery of a display unit. There is provided a resin to prevent an optical adhesive from infiltrating into a gap between the metal bezel and the display panel. In this case, the optical adhesive is provided on an entire surface of the display device, whereby the transparent flat body is bonded to the display device. The transparent flat body has a size different from a size of the metal bezel of the display device. As described above, a transparent plate for protection, a transparent touch panel, or the like is referred to by the transparent flat body. The display panel generally has a transparent substrate, and an appropriate optical film is provided on a surface of the transparent substrate according to specifications of the display panel.

Here, a structure is made such that the resin is provided between the optical film of the display surface and the metal bezel. Alternatively, the structure is made such that the resin is provided between the transparent substrate and the metal bezel.

In the structure where an optical film smaller than the transparent substrate is provided on the transparent substrate forming the display panel, the metal bezel presses a periphery portion of the transparent substrate. Then, a tape material is provided so as to cover a gap between the optical film and the metal bezel, and the tape material is provided with a function of the aforementioned resin. The tape material may also be provided to cover an entire surface of the optical film and an entire surface of the metal bezel. In other case, a potting material is provided to fill the gap between the optical film and the metal bezel, whereby the potting material is provided with the function of the aforementioned resin.

Alternatively, in the structure where the optical film is provided on the transparent substrate forming the display panel, and the metal bezel is brought into contact with the periphery portion of the optical film, an adhesive may be provided in a step formed of an end surface of the metal bezel and a surface of the optical film to be provided with the function of the aforementioned resin.

Further, in each of the aforementioned structures, when the resin is provided with conductivity, a structure where an electric charge which is charged in the display panel escapes to the metal bezel via the resin, which makes it possible to realize counter-measures against static for the display device with a simple structure.

Hereinafter, a detailed description is given on a structure where a liquid crystal panel is used as the display panel, a transparent plate for protection is used as the transparent flat body, and a light curable adhesive is used as the optical adhesive.

### Embodiment 1

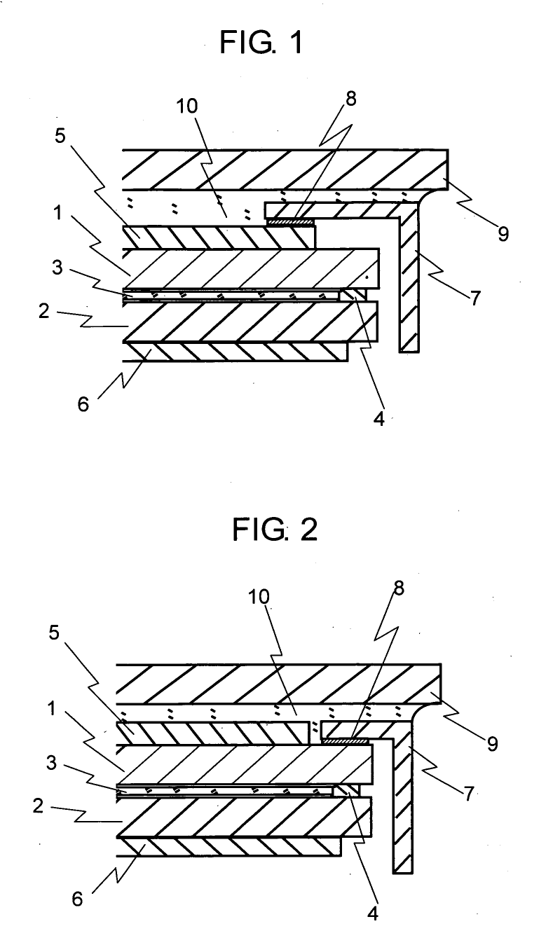

FIG. 1 schematically shows a cross-sectional structure of a liquid crystal display device used in this embodiment. An adhesive tape 8 is used as a resin for preventing infiltration. On a glass substrate 1 of a display unit side, a color filter is formed, and a thin film transistor (TFT) device is formed on a counter substrate 2. Liquid crystal 3 is sealed between the glass substrate 1 and the counter substrate 2 using a sealing compound 4. A light absorption polarizing plate 5 is provided on a surface of the glass substrate 1, an optical film 6 in which a light reflection polarizing plate and a light absorption polarizing plate are laminated is provided on a surface of the counter substrate 2.

Among light emitted from a backlight (not shown) disposed on a back side of the display panel, light emitted in one vibration direction permeates the optical film 6 and enters a liquid crystal layer. A molecular direction of the liquid crystal is controlled by an electrical signal applied to a TFT formed for each pixel, and a vibration direction of the entrance of light is changed. An image is displayed when the light entering the liquid crystal layer passes through or is absorbed by the polarizing plate 5 of a display surface side.

A metal bezel 7 which is made of stainless steel and has an opening in the display area is fixed to the polarizing plate 5 of the display surface side by the adhesive tape 8. The metal bezel 7 is fixed to a frame (not shown) of the backlight by a screw or fitting. In this manner, the display panel is fixed to the frame by the metal bezel 7. The metal bezel 7 is bonded to the polarizing plate 5 without a gap by the adhesive tape 8. A transparent plate 9 formed of a strengthened glass with a thickness of 1.0 mm is bonded to the liquid crystal display device in an entire region including the display unit and the metal bezel by curing the liquid light curable adhesive 10.

The liquid light curable adhesive before curing does not penetrate the adhesive tape 8, and thus the liquid light curable adhesive does not flow between the metal bezel 7 and the display device. Further, a transparent conductive film is formed on a surface of the polarizing plate 5, and a conductive adhesive tape is used, whereby the metal bezel 7 is electrically connected to the transparent conductive film. In this embodiment, the polarizing plate 5 of a smaller size compared with the glass substrate 1 is attached. A thickness of the polarizing plate 5 is 130 μm, a thickness of the adhesive tape 8 is 25 μm, and a thickness of the metal bezel 7 is 100 μm. As a light curable adhesive, a UV adhesive is widely used.

### Embodiment 2

FIG. 2 schematically shows a cross-sectional structure of a liquid crystal display device used in this embodiment. The same components as the components of Embodiment 1 are denoted by the same reference numerals, and the overlapping description is omitted. Embodiment 2 is different from Embodiment 1 in that the adhesive tape 8 is provided between the metal bezel 7 and the glass substrate 1 of the display panel. The metal bezel 7 is fixed to the glass substrate 1 of the display surface side by the adhesive tape 8. The metal bezel 7 is bonded to the glass' substrate 1 without a gap by the adhesive tape 8. The transparent plate 9 made of the strengthened glass is entirely bonded to the liquid crystal display device including the display unit and the metal bezel by the light curable adhesive 10. In this case, the polarizing plate 5 has a smaller size compared with the glass substrate 1.

The liquid light curable adhesive before curing does not penetrate the adhesive tape 8, and thus the liquid curable adhesive does not flow out. The transparent conductive film may be formed on the surface of the glass substrate 1, and the conductive adhesive tape may be used, whereby the metal bezel 7 is electrically connected to the transparent conductive film. In Embodiment 1, there is a difference between the thickness of the adhesive between the polarizing plate 5 and the transparent plate 9, and the thickness of the adhesive between the metal bezel 7 and the transparent plate 9 by the thickness of the metal bezel 7 and the thickness of the adhesive tape 8. However, in this embodiment, the thickness of the adhesive can be made more uniform.

### Embodiment 3

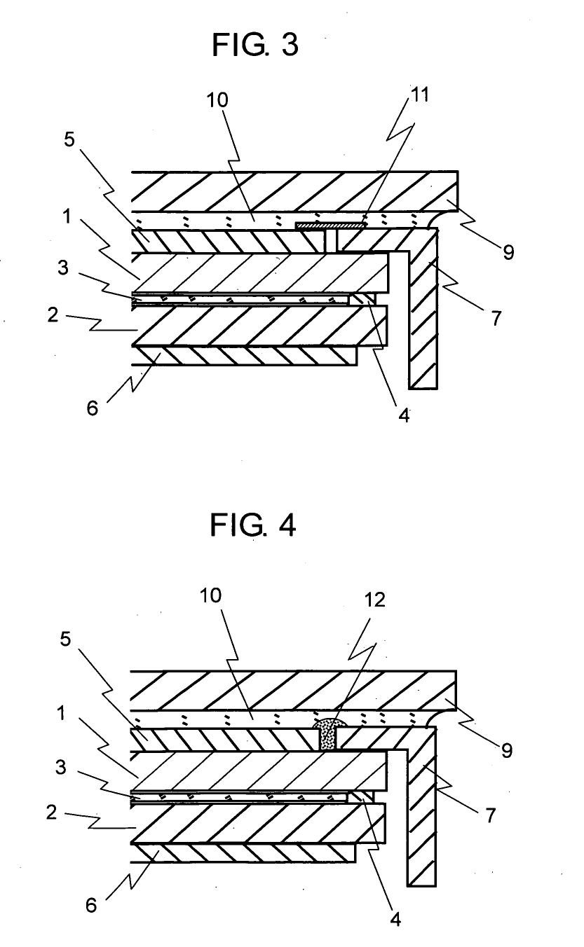

FIG. 3 schematically shows a cross-sectional structure of a liquid crystal display device used in this embodiment. The same components as the components of the aforementioned embodiments are denoted by the same reference numerals, and the overlapping description is omitted. Embodiment 3 is different from the aforementioned embodiments in a fixation structure of the metal bezel 7. The metal bezel 7 is brought into contact with a periphery portion of the surface of the glass substrate 1, and is fixed to the frame (not shown) of the backlight by a screw or fitting. Further, a tape 11 including a polyethylene terephthalate (PET) base material is attached to the metal bezel 7 and the polarizing plate 5 of the display panel over an entire periphery thereof from the above. The transparent plate 9 is entirely bonded to the liquid crystal display device of the aforementioned structure including the display unit and the metal bezel by curing the liquid light curable adhesive 10. Here, the tape 11 is provided with a function of a resin layer for preventing penetration.

The liquid light curable adhesive before curing does not penetrate the tape 11, and thus the liquid curable adhesive does not flow out. The transparent conductive film may be formed on the surface of the polarizing plate 5, and the conductive adhesive tape may be used, whereby the metal bezel 7 is electrically connected to the transparent conductive film. Alternatively, a transparent conductive layer is formed on the surface of the glass substrate 1, whereby this portion can be brought into contact with the metal bezel 7 to be electrically connected.

### Embodiment 4

FIG. 4 schematically shows a cross-sectional structure of a liquid crystal display device used in this embodiment. The same components as the components of the aforementioned embodiments are denoted by the same reference numerals, and the overlapping description is omitted. Embodiment 3 is different from the aforementioned embodiments in the fixation structure of the metal bezel 7.

The metal bezel 7 is brought into contact with the periphery portion of the surface of the glass substrate 1, and is also fixed to the frame (not shown) of the backlight by a screw or fitting. An adhesive 12 is filled between the metal bezel 7 and the polarizing plate 5. In this case, the adhesive 12 is provided with a function of the resin layer for preventing penetration. The transparent plate 9 is entirely bonded to the liquid crystal display device of the aforementioned structure including the display unit and the metal bezel by curing the liquid light curable adhesive 10.

A viscosity of the adhesive 12 before curing is desirably high to some extent, and is preferably from 10,000 CP to 20,000 CP. The display panel is affected during curing by a thermal curing adhesive, and thus an ultra violet curable adhesive or a dry type of adhesive which does not require much heat is preferred.

The liquid light curable adhesive before curing does not penetrate the adhesive 12, and thus the liquid curable adhesive does not flow out. Besides, the transparent conductive film may be formed on the surface of the polarizing plate 5, and the conductive adhesive 12 may be used, whereby the metal bezel 7 is electrically connected to the transparent conductive film. One type or multiple types of the adhesive 12 may be used, and the insulating adhesive and the conductive adhesive may be used. Alternatively, the transparent conductive layer may be formed on the surface of the glass substrate 1 to be electrically connected to the metal bezel 7.

### Embodiment 5

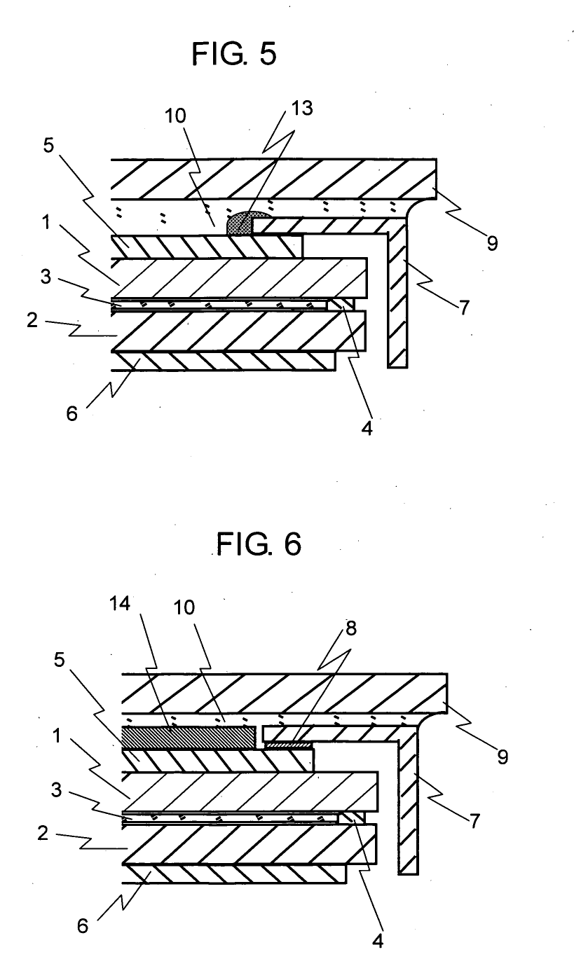

FIG. 5 schematically shows a cross-sectional structure of a liquid crystal display device used in this embodiment. The same components as the components of the aforementioned embodiments are denoted by the same reference numerals, and the overlapping description is omitted.

The metal bezel 7 is brought into contact with the polarizing plate 5 provided in the display panel, and is fixed to the frame (not shown) of the backlight by a screw or fitting. An adhesive 13 is applied to a step portion formed of the metal bezel 7 and the polarizing plate 5, and is cured. In other words, the adhesive 13 is provided on an edge surface of the metal bezel 7 and the surface of the polarizing plate 5, and is provided with the function of the resin layer for preventing penetration. The transparent plate 9 is entirely bonded to the liquid crystal display device of the aforementioned structure including the display unit and the metal bezel by curing the liquid light curable adhesive 10.

A viscosity of the adhesive 13 before curing is desirably high to some extent, and is preferably from 10,000 CP to 20,000 CP. The display panel is affected during curing by the thermal curing adhesive, and thus an ultra violet curable adhesive or a dry type of adhesive which does not require much heat is preferred.

The liquid light curable-adhesive before curing does not penetrate the adhesive 13, and thus the liquid curable adhesive does not flow out. The transparent conductive film may be formed on the surface of the polarizing plate 5, and the conductive adhesive 13 may be used, whereby the metal bezel 7 is electrically connected to the transparent conductive film. One type or multiple types of the adhesive 13 may be used, and the insulating adhesive and the conductive adhesive may be used.

### Embodiment 6

FIG. 6 schematically shows a cross-sectional structure of a liquid crystal display device used in this embodiment. The same components as the components of Embodiment 1 are denoted by the same reference numerals, and the overlapping description is omitted. Embodiment 6 is different from Embodiment 1 in that a transparent film 14 is provided on the surface of the display panel, that is, on the polarizing plate 5.

As shown in FIG. 6, the adhesive tape 8 is provided between the metal bezel 7 and the polarizing plate 5 of the display panel. The metal bezel 7 is bonded to the polarizing plate 5 without a gap with the adhesive tape 8, and the adhesive tape 8 is provided with the function of the resin layer for preventing penetration. The transparent plate 9 is entirely bonded to the liquid crystal display device of the aforementioned structure including the display unit and the metal bezel by curing the liquid light curable adhesive 10. When the transparent film 14 is provided on the polarizing plate 5, the thickness of the adhesive of each portion, that is, the thickness of the metal bezel 7 and the thickness of the transparent film 14, become substantially uniform, and thus bubbles generated when the liquid adhesive is filled can be reduced. If there is no fear of bubble entrainment, the transparent film 14 may be bonded to the transparent plate 9 side, or a transparent film having an appropriate thickness may be bonded to each of the polarizing plate 5 and the transparent plate 9.

Here, the description has been made on a case where the transparent film 14 is provided based on the structure of Example 1, but the description may be given based on the structure of Example 5.

### Embodiment 7

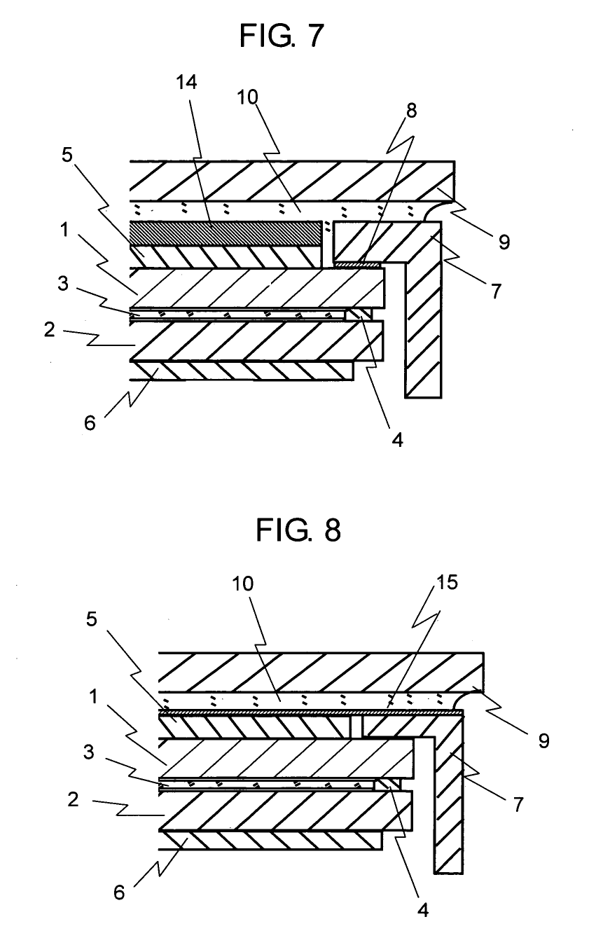

FIG. 7 schematically shows a cross-sectional structure of a liquid crystal display device used in this embodiment. The same components as the components of Embodiment 2 are denoted by the same reference numerals, and the overlapping description is omitted. Embodiment 7 is different from the aforementioned embodiments in that the thickness of the portion of the metal bezel 7 which is brought into contact with the display panel is larger compared with a thickness of the polarizing plate. The adhesive tape 8 is provided between the metal bezel 7 made of stainless steel and the glass substrate 1 of the display surface side. The metal bezel 7 is bonded to the glass substrate 1 without a gap with the adhesive tape 8. In this embodiment, the thickness of the metal bezel 7 is about 200 μm in a portion of being brought into contact with the glass substrate 1. The thickness of the adhesive tape 8 is about 30 μm.

When there is a step between the surface of the polarizing plate 5 and the surface of the metal bezel 7, the adhesive greatly flows, bubbles are easily generated, and also the adhesive layer becomes thicker. Thus, the transparent film 14 is provided on the polarizing plate 5. In order to prevent the occurrence of the bubbles caused by flowing adhesive, the step of the adhesive surfaces needs to be made 50 μm or less, and preferably 30 μm or less. In this embodiment, when the thickness of the polarizing plate 5 is 130 μm, there is almost no step between the adhesive surfaces by the use of the transparent film 14 having a thickness of 100 μm, which makes the adhesive surfaces flat. The use of the transparent film 14 can make the adhesive layer thinner by about 100 μm, and thus an amount of the costly adhesive usage can be reduced. If there is no fear of bubble entrainment, the transparent film 14 may be bonded to the transparent plate 9 side, or a transparent film having an appropriate thickness may be bonded to each of the polarizing plate 5 and the transparent plate 9.

### Embodiment 8

FIG. 8 schematically shows a cross-sectional structure of a liquid crystal display device used in this embodiment. The same components as the components of Embodiment 3 are denoted by the same reference numerals, and the overlapping description is omitted. Embodiment 8 is different from Embodiment 3 in that a transparent film 15 formed of a PET material is provided on the entire surface of the metal bezel 7 and the entire surface of the polarizing plate 5.

The metal bezel 7 presses the display panel by its frame portion. As shown in FIG. 8, in this embodiment, the metal bezel 7 fixes the glass substrate 1 on the periphery portion of its surface. Further, the transparent film 15 is attached to the metal bezel 7 and the polarizing plate 5 so as to cover the entire surface of the metal bezel 7 and the entire surface of the optical film 5 from thereabove. The transparent plate 9 is entirely bonded to the liquid crystal display device of the aforementioned structure including the display unit and the metal bezel by curing the liquid light curable adhesive 10.

The liquid light curable adhesive before curing does not penetrate the transparent film 15, and thus the liquid curable adhesive does not flow out. The transparent conductive film may be formed on the surface of the transparent film 15 to be electrically connected to the metal bezel 7. If there is no problem in handling, the transparent film is preferably made as thin as possible.

In the respective embodiments described above, the strengthened glass is taken as an example of the transparent plate, but a resin plate such as an acrylic resin plate or a polycarbonate resin plate may be used. Alternatively, the touch panel can be used. In the case of the analog resistive touch panel, a thickness of the glass substrate is 0 7 mm, and a thickness of the film substrate is 175 μm. Further, the display is not limited to the liquid crystal display, and the plasma display, the organic EL display, the inorganic EL display, the FED, the electronic paper, or the like can be used.

According to the present invention, the employment of the structure where the display panel with a metal bezel is entirely bonded to the transparent flat body with the optical adhesive solves the problem that an adhesive penetrates a gap between the metal bezel and the display panel. At the same time, as a countermeasure for static electricity, the transparent conductive film formed on the display surface is conducted by the metal bezel to be connected to GND. As publicly known, the transparent conductive film is easily connected to GND from the metal bezel because of its structure. Alternatively, when there is the step between the metal bezel and the display panel, the transparent film is provided between the display panel and the metal bezel to fill the step, whereby the amount of the optical adhesive usage can be reduced and the occurrence of bubbles can be reduced.

What is claimed is:

1. An electronic device comprising a transparent flat body and a display device, the transparent flat body being bonded to the display device with an optical adhesive, wherein:
the display device has a structure where a display panel is fixed by a metal bezel provided on a periphery of the display unit, and is provided with a resin so that the optical adhesive is prevented from permeating a gap between the metal bezel and the display panel; and
the optical adhesive is provided on an entire surface of the display device so that the transparent flat body is bonded to the display device.

2. An electronic device according to claim 1, wherein the resin is provided between the metal bezel and an optical film provided on a display surface of the display panel.

3. An electronic device according to claim 1, wherein the resin is provided between a transparent substrate forming the display panel and the metal bezel.

4. An electronic device according to claim 1, wherein:
the display panel comprises the transparent substrate, the transparent substrate being provided with an optical film smaller than the transparent substrate, and the metal bezel is brought into contact with a periphery portion of the transparent substrate; and
the resin comprises a tape material provided to cover a gap between the optical film and the metal bezel.

5. An electronic device according to claim 4, wherein the tape material comprises a transparent film provided to cover an entire surface of the optical film and an entire surface of the metal bezel.

6. An electronic device according to claim 1, wherein:
the display panel comprises a transparent substrate, the transparent substrate being provided with an optical film smaller than the transparent substrate, and the metal bezel is brought into contact with a periphery portion of the transparent substrate; and
the resin comprises a potting material provided to fill a gap between the optical film and the metal bezel.

7. An electronic device according to claim 1, wherein:
the display panel comprises a transparent substrate, the transparent substrate being provided with an optical film, and the metal bezel is brought into contact with a periphery portion of the optical film; and
the resin comprises an adhesive provided on a step formed by an edge surface of the metal bezel and a surface of the optical film.

8. An electronic device according to claim 1, wherein the resin has conductivity, and an electric charge charged in the display panel escapes from the metal bezel via the resin.
